(19) United States
(12) Patent Application Publication
(10) Pub. No.: US 2020/0142756 A1
(43) Pub. Date: May 7, 2020

(54) ADAPTER WITH INSTRUMENT CONTROL FUNCTION, INSTRUMENT CONTROL SYSTEM AND INSTRUMENT CONTROL METHOD

(71) Applicant: Primax Electronics Ltd., Taipei (TW)

(72) Inventors: Cheng-Yi Tsai, Taipei (TW); Ying-Che Tseng, Taipei (TW); Shi-Jie Zhang, Taipei (TW); Che-Yen Huang, Taipei (TW)

(21) Appl. No.: 16/236,021

(22) Filed: Dec. 28, 2018

(30) Foreign Application Priority Data
Nov. 2, 2018 (TW) 107139011

(51) Int. Cl. G06F 9/54; G06F 9/445; G06F 9/48; G06F 13/10

(52) U.S. Cl. CPC G06F 9/541; G06F 13/102; G06F 9/48; G06F 9/445

(57) ABSTRACT

An adapter with an instrument control function, an instrument control system and an instrument control method are provided. The instrument control system includes a computer and a measuring instrument. The measuring instrument has a characteristic data. The computer and the measuring instrument are in communication with a first transmission interface and a second transmission interface of the adapter, respectively. The adapter detects the characteristic data, and compares the characteristic data with a database of the adapter. If a specified parameter profile corresponding to the characteristic data is present in the database according to the comparing result, the specified parameter profile is transmitted to the computer through the first transmission interface. A setting of a test program is completed according to the specified parameter profile. Consequently, the test program executes a task of testing the measuring instrument.

### FIELD OF THE INVENTION

The present invention relates to an adapter with an instrument control function, an instrument control system and an instrument control method, and more particularly to an adapter, an instrument control system and an instrument control method capable of automatically setting and executing a test task through a computer.

### BACKGROUND OF THE INVENTION

With increasing development of science and technology, various electronic products such as 3C electronic devices are widely used in daily lives of people. In the modern electronic factories, electronic products have to be tested before the electronic products leave the factories. In addition to an in-circuit test, the electronic products have to undergo a functional circuit test prior to shipment. The in-circuit test is a circuitry test or an electrical property test for complying with the electric safety regulations. In accordance with the conventional technologies, a test program and a measuring instrument are collaboratively used to perform the functional circuit test so as to realize the quality of the product.

Generally, the method of performing the in-circuit test comprises the following steps. Firstly, a measuring instrument is connected with a computer. Then, a program code or driver capable of identifying the measuring instrument is loaded to the computer. Then, a test program is executed in the computer. After an electronic product is tested by the measuring instrument, the test result is transmitted to the computer and shown through the test program. Consequently, the test result can be observed and judged by the operator or the engineer.

The measuring instruments are in communication with the computer to transmit signals through transmission interfaces. According to the purposes or test types of the measuring instruments, the measuring instruments and the transmission interfaces have various specifications. For example, the transmission interface includes a universal serial bus (USB), a general purpose interface bus (GPIB), an Ethernet interface, a serial port or any other appropriate transmission interface. For example, the serial port includes a RS232 port, a RS422 port, a RS485 port or a line printer terminal port (LPT port).

As mentioned above, the measuring instruments and the transmission interfaces may have different specifications. In addition, the measuring instruments complying with the same specification may have different styles or model numbers. For example, the ammeters produced by HP Company have different versions (e.g., 34401A and 34461A). For communicating different measuring instruments with the test program of the computer, the program codes or drivers corresponding to the measuring instruments have to be loaded into the computer. Moreover, whenever the measuring instrument is in communication with the computer, it is necessary to make associated settings of the measuring instrument in the computer.

For example, the operator or the engineer has to inquire about the Baud rate, the command response time or the specified parameters of the connected measuring instrument in the test program of the computer and thus the setting is made. If the parameter profiles are erroneous, the detection result is possibly unable to be read or erroneously read. Generally, the test task in the production line may need more than one measuring instrument. Whenever the operator or the engineer changes the measuring instrument, associated settings of the measuring instrument in the computer should be made. If the test task is complicated, the setting process becomes a heavy burden.

When a manufacturer introduces a new style of measuring instrument, the test program of the computer has to be updated and modified even if there is only a partial difference in the program code or driver for controlling the measuring instrument. In addition, the settings of the measuring instrument should be made when the measuring instrument is connected with the computer. In other words, whenever the measuring instrument is changed (e.g., the type or the style of the measuring instrument is changed), the computer has to perform an associated action. Consequently, the conventional method is time-consuming and labor-intensive.

On the other hand, if the measuring instrument of the old style is possibly used in the future, the corresponding program code or driver has to be retained. Under this circumstance, the maintenance cost is increased. Since the data amount of the programs used in the production line is very large, the manual error about the maintenance is increased. Moreover, if the authorization period of the measuring instrument has passed, the service of the manufacturer is unavailable. Alternatively, it is difficult to search and download the program code or driver. In other words, it is difficult to operate the measuring instrument of the old style. If the measuring instrument of the old style is replaced with a new style, purchasing the new measuring instrument is not cost-effective.

For overcoming the drawbacks of the conventional technologies, there is a need of providing an improved technology to simplify the production and test task and reduce the labor cost, the time cost and the manual operation error.

### SUMMARY OF THE INVENTION

The present invention provides an adapter with an instrument control function, an instrument control system and an instrument control method. In accordance with the technology of the present invention, the setting data corresponding to the measuring instruments of various model numbers are obtained after detection and comparison. Consequently, the settings of the test program are automatically completed in the computer. In such way, the erroneous probability of the manual settings and the setting time will be reduced.

In accordance with an aspect of the present invention, there is provided an adapter with an instrument control function. The adapter is connected between a computer and at least one measuring instrument. A test program is installed in the computer. Each of the at least one measuring instrument has a characteristic data. The adapter includes a first transmission interface, a second transmission interface, a memory unit and a processing unit. The first transmission interface is in communication with the computer. The second transmission interface is in communication with the at least one measuring instrument. A database is recorded in the memory unit. The database contains plural parameter profiles. The processing unit detects the characteristic data of the at least one measuring instrument that is in communication with the second transmission interface and judges a comparing result of comparing the characteristic data with the database. If a specified parameter profile of the plural parameter profiles corresponding to the characteristic data is present in the database according to the comparing result, the specified parameter profile is transmitted from the processing unit to the computer through the first transmission interface. A setting of the test program is completed according to the specified parameter profile. The test program executes a task of testing the corresponding measuring instrument.

In accordance with another aspect of the present invention, there is provided an instrument control system. The instrument control system includes a computer, at least one measuring instrument and an adapter. A test program is installed in the computer. Each of the at least one measuring instrument has a characteristic data. The adapter is connected between the computer and the at least one measuring instrument. adapter includes a first transmission interface, a second transmission interface, a memory unit and a processing unit. The first transmission interface is in communication with the computer. The second transmission interface is in communication with the at least one measuring instrument. A database is recorded in the memory unit. The database contains plural parameter profiles. The processing unit detects the characteristic data of the at least one measuring instrument that is in communication with the second transmission interface and judges a comparing result of comparing the characteristic data with the database. If a specified parameter profile of the plural parameter profiles corresponding to the characteristic data is present in the database according to the comparing result, the specified parameter profile is transmitted from the processing unit to the computer through the first transmission interface. A setting of the test program is completed according to the specified parameter profile. The test program executes a task of testing the corresponding measuring instrument.

In accordance with a further aspect of the present invention, there is provided an instrument control method for an instrument control system. The instrument control system includes a computer, at least one measuring instrument and an adapter. A test program is installed in the computer. Each of the at least one measuring instrument has a characteristic data. The instrument control method includes the following steps. Firstly, the computer is in communication with the first transmission interface of the adapter, and the at least one measuring instrument is in communication with a second transmission interface of the adapter. Then, a processing unit of the adapter detects the characteristic data of the at least one measuring instrument that is in communication with the second transmission interface, and judges a comparing result of comparing the characteristic data with a database of the adapter. If a specified parameter profile of the plural parameter profiles corresponding to the characteristic data is present in the database according to the comparing result, the specified parameter profile is transmitted from the processing unit to the computer through the first transmission interface. A setting of the test program is completed according to the specified parameter profile. The test program executes a task of testing the corresponding measuring instrument.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of an instrument control system according to an embodiment of the present invention;

FIG. 2 schematically illustrates the contents of the database in the adapter of the instrument control system according to the embodiment of the present invention; and

FIG. 3 is a flowchart illustrating an instrument control method according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

The present invention provides an adapter with an instrument control function, an instrument control system and an instrument control method.

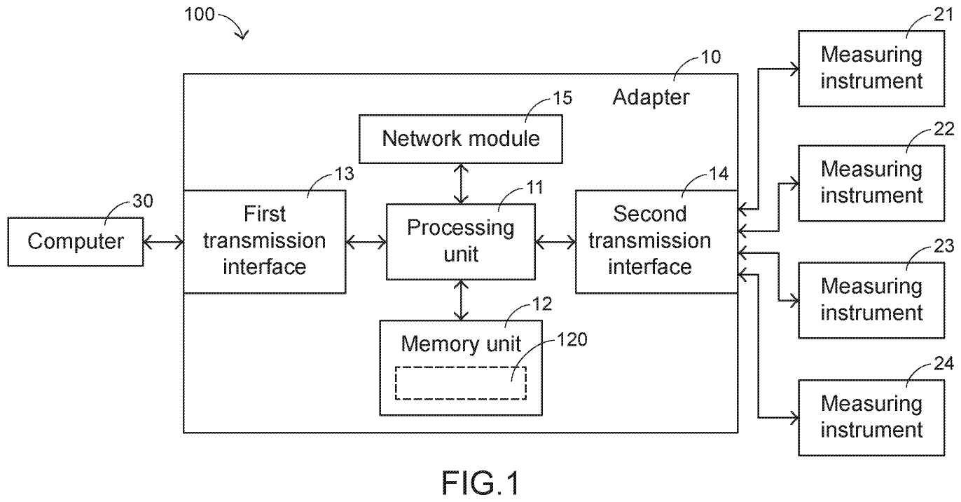

FIG. 1 is a schematic functional block diagram illustrating the architecture of an instrument control system according to an embodiment of the present invention. As shown in FIG. 1, the instrument control system 100 comprises a computer 30, plural measuring instruments 21˜24 and an adapter 10. The four measuring instruments are presented herein for illustration only. The measuring instruments 21˜24 and the computer 30 are in communication with the adapter 10. In this embodiment, the adapter 10 comprises a first transmission interface 13 and a second transmission interface 14. The adapter 10 is in communication with the computer 30 through the first transmission interface 13. The adapter 10 is in communication with the measuring instruments 21˜24 through the second transmission interface 14.

The specifications of the transmission interfaces of the measuring instruments 21˜24 may be identical or different. For example, the transmission interface includes a universal serial bus (USB), a general purpose interface bus (GPIB), an Ethernet interface, a serial port or any other appropriate transmission interface. For example, the serial port includes a RS232 port, a RS422 port, a RS485 port or a line printer terminal port (LPT port). The types of the measuring instruments 21˜24 may be identical or different. For example, each of the measuring instruments 21˜24 includes an ammeter for measuring the current, a wireless detector for detecting the condition of receiving and transmitting the wireless signal, a spectrum analyzer or any other appropriate measuring instrument. In other words, the second transmission interface 14 comprises plural transmission ports (not shown) to be connected with plural measuring instruments. These transmission ports comply with the transmission specifications of the transmission interfaces of the measuring instruments 21˜24.

In the above embodiment as shown in FIG. 1, the instrument control system 100 comprises four measuring instruments. It is noted that the number of the measuring instruments is not restricted. That is, the adapter 10 is in communication with at least one measuring instrument according to the practical requirements. In case that the second transmission interface 14 comprises plural transmission ports, the measuring instrument to be connected with the second transmission interface 14 should comply with the specification of the corresponding transmission port of the second transmission interface 14.

The computer 30 is a personal computer or a notebook computer with a standalone power source. Moreover, the computer 30 provides electric energy to power the adapter 10. In an embodiment, the instrument control system 100 further comprises a power supply (not shown). The power supply provides electric energy to power the measuring instruments 21˜24.

The instrument control method of the present invention is designed according to the settings of a program code or a firmware component. In addition, the program code or the firmware component for the instrument control method may be recorded in a memory unit of the adapter 10. For example, the memory unit is a flash memory (not shown). The program code or the firmware component is executed according to the operations of the associated hardware component. For example, when one measuring instrument is in communication with the corresponding transmission port, the program code or the firmware component is executed. Moreover, the adapter 10 further comprises a processing unit and a memory unit 12 for implementing the comparing, judging and controlling operations.

In other words, the instrument control method of the present invention is an instrument control mechanism for controlling plural measuring instruments. The instrument control method of the present invention is capable of automatically searching and converting the corresponding setting resources according to the model numbers or types of the connected measuring instruments in order to control the connected measuring instruments.

For achieving the above purposes, the technologies of the present invention have many features. In accordance with a feature, the memory unit 12 has a database 120. Moreover, plural parameter profiles corresponding to the measuring instruments of different model numbers, types or versions are stored in the database 120. For example, the parameter profiles in the database 120 are obtained after the program codes or drivers of plural measuring instruments available in the market are collected and managed. The program codes or the drivers are the required sources when the corresponding measuring instruments are enabled. The parameter profile further contains the set values of associated parameters (e.g., the Baud rate).

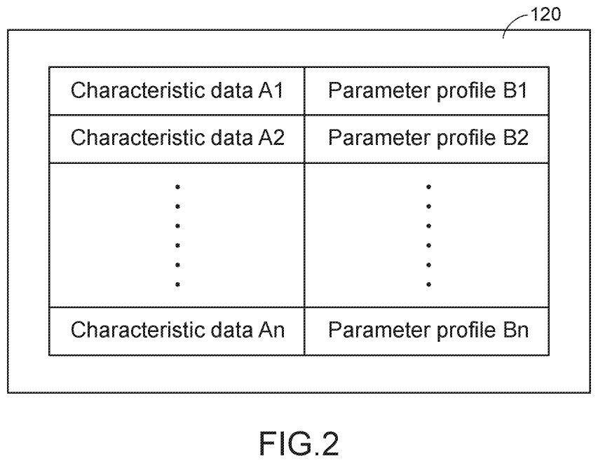

FIG. 2 schematically illustrates the contents of the database in the adapter of the instrument control system according to the embodiment of the present invention. As shown in FIG. 2, plural characteristic data and plural parameter profiles are recorded in the database 120. For example, n characteristic data A1˜An and n parameter profiles B1˜Bn are recorded in the database 120. The n characteristic data A1˜An correspond to the n parameter profiles B1˜Bn, respectively. Each of the measuring instruments 21˜24 contains a characteristic data. This characteristic data is related to the device name, the device model number, the device specification, the device manufacturer, the device number or the product identification number of the corresponding measuring instrument. It is noted that each measuring instrument has the different, unique and distinguishable characteristic data.

As mentioned above, each parameter profile contains the corresponding program code or driver. In addition, the parameter profile and the corresponding characteristic data are recorded in the database 120. For example, the characteristic data A1 corresponds to the parameter profile B1, and the characteristic data A2 corresponds to the parameter profile B2. In a situation, the same type of measuring instrument from the same manufacturer may have a different program code or driver because of the style or version difference. Under this circumstance, it is necessary to collect and record the characteristic data. In another situation, two measuring instruments have the same type, style and model number and have different device numbers or product identification numbers. Since these two measuring instruments have the same program code or driver, one characteristic data corresponding to one model number is recorded.

Like the conventional technology, a test program is previously installed in the computer 30. The test program is stored in an associated memory unit (not shown) of the computer 30. When the test program is executed, the user can monitor and operate the operations of the instrument control system through a user interface shown on a display screen of the computer 30. For example, the user can monitor where any measuring instrument is connected with the second transmission interface 14. Moreover, the test program and the user interface can be applied to all measuring instruments. However, in case that some parameter profiles are not present, the computer 30 may search, compare, convert and record the associated setting resources.

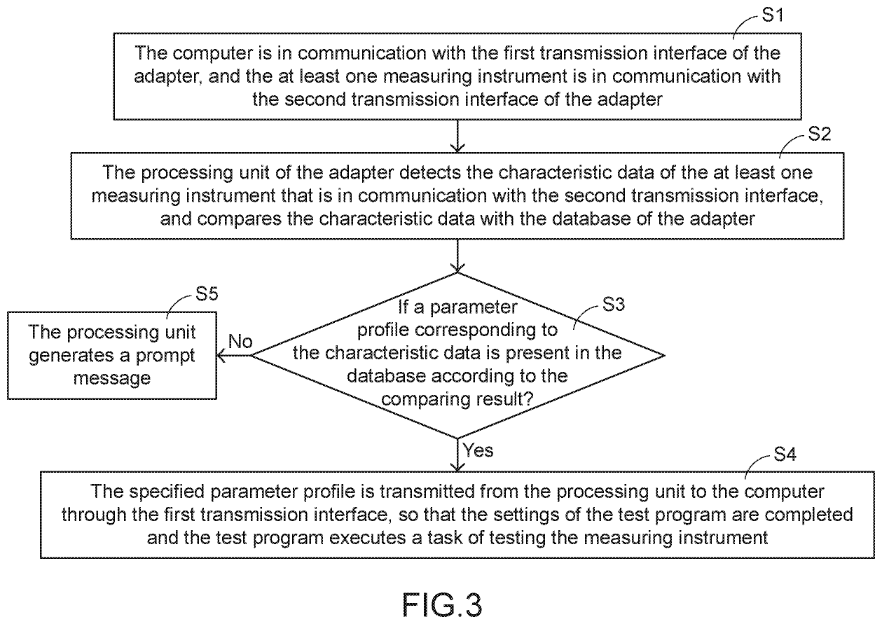

FIG. 3 is a flowchart illustrating an instrument control method according to an embodiment of the present invention.

Firstly, the computer 30 is in communication with the first transmission interface 13 of the adapter 10, and at least one measuring instrument is in communication with the second transmission interface 14 of the adapter 10 (Step S1).

Then, the processing unit 11 of the adapter 10 detects the characteristic data of the at least one measuring instrument that is in communication with the second transmission interface 14, and compares the characteristic data with the database 120 of the adapter 10 (Step S2).

Then, the processing unit 11 judges whether a parameter profile corresponding to the characteristic data is present in the database 120 according to the comparing result (Step S3).

If a specified parameter profile corresponding to the characteristic data is present in the database 120 according to the comparing result, the specified parameter profile is transmitted from the processing unit 11 to the computer 30 through the first transmission interface 13. Consequently, the settings of the test program are completed, and the test program executes a task of testing the measuring instrument (Step S4).

Whereas, if no parameter profile corresponding to the characteristic data is present in the database 120 according to the comparing result, the processing unit 11 generates a prompt message (Step ss).

In the step S1, the computer 30 is a personal computer or a notebook computer. After the computer 30 is connected with the adapter 10, the computer 30 provides electric energy to power the adapter 10. In an embodiment, the first transmission interface 13 of the adapter 10 is a USB interface. Consequently, the first transmission interface 13 is capable of transmitting electric energy and signals. The number and types of the measuring instruments are determined according to the test requirements. Consequently, transmission specifications of the transmission interfaces of the measuring instruments must comply with the specifications of the corresponding transmission ports of the second transmission interface 14.

After a measuring instrument is connected with the corresponding transmission port of the second transmission interface 14 through a signal wire complying with the corresponding specification, the characteristic data of the measuring instrument is transmitted to the adapter 10 (i.e., in the step S2). Moreover, the characteristic data is received and read by the processing unit 11. Like the conventional technology, the computer can identify the model of the measuring instrument (i.e., the characteristic data) after the connection between the measuring instrument and the computer is established. Consequently, the processing unit 11 of the adapter 10 is also able to detect the characteristic data of the connected measuring instrument.

While the processing unit 11 compares the characteristic data with the database 120, the processing unit 11 searches whether a record about the characteristic data is contained in the database 120. For example, as shown in FIG. 2, n characteristic data A1˜An are recorded in the database 120. In other words, the processing unit 11 searches whether the characteristic data of the measuring instrument is identical to one of the n characteristic data A1˜An. For example, the processing unit 11 judges whether the device number of the connected measuring instrument is recorded in the characteristic data A1˜An. If the device number of the connected measuring instrument is recorded in one of the characteristic data A1˜An, the corresponding parameter profile of the parameter profiles B1˜Bn is acquired.

Please refer to the steps S3 and S4 as shown in FIG. 3. In case that the characteristic data of the measuring instrument is identical to one of the n characteristic data, the corresponding parameter profile is obtained. The parameter profile is the program code or driver for operating the connected measuring instrument. In this embodiment, it is assumed that the corresponding parameter setting of the computer 30 has not been completed before the measuring instrument is connected with the computer 30. That is, the computer 30 does not have the program code or driver of the measuring instrument before the measuring instrument is connected with the computer. If a specified parameter profile corresponding to the characteristic data is present in the database 120 according to the comparing result, the specified parameter profile is transmitted from the processing unit 11 to the computer 30 through the first transmission interface 13. Consequently, the setting of the test program is completed.

In some situations, the corresponding parameter setting of the computer 30 has been completed before the measuring instrument is connected with the computer 30. That is, the measuring instrument has been controlled by the computer 30, and the program code or driver has been recorded in the computer 30. Generally, it is not necessary to transmit the specified parameter profile from the processing unit 11 to the computer 30. Under this circumstance, the processing unit 11 issues a signal to inquire or check whether the setting data of the measuring instrument has been loaded to the computer 30. Moreover, the computer 30 responds to the processing unit 11 for confirmation.

Please refer to the steps S3 and S5 as shown in FIG. 3. In case that the characteristic data of the measuring instrument is not identical to any of the n characteristic data, the parameter profile corresponding to the model number, type or version of the measuring instrument is not recorded in the database 120. Meanwhile, no record about the characteristic data of the measuring instrument is contained in the database 120. In the above embodiment, it is assumed that the program codes or drivers of the possible and known measuring instruments for performing the test task have been collected and managed in the database 120. That is, a specified parameter profile corresponding to the characteristic data of the measuring instrument is present in the database 120 and transmitted to the computer 30.

As mentioned above, if no parameter profile corresponding to the characteristic data is present in the database 120 according to the comparing result, the processing unit 11 generates the prompt message. The prompt message is used to attract the user's attention. For example, the prompt message is a text, pattern or sound that is shown on or generated by the computer 30 (e.g., through a display screen or a loudspeaker). According to prompt message, the user realizes that the currently connected measuring instrument is a new measuring instrument for the database 120. Meanwhile, the measuring instrument cannot be controlled by the computer 30.

Please refer to the step S4 of FIG. 3. After the setting about the parameter profile of the connected measuring instrument is completed, the computer 30 controls the measuring instrument to execute the test task. For example, the test program in the computer 30 issues a control command. After control command control command is converted through the specified parameter profile, the converted control command is transmitted to the corresponding measuring instrument and the test task is executed. As mentioned above, the program code or driver for controlling the measuring instrument has been loaded to the computer 30. Meanwhile, the adapter 10 can be considered as an expansion interface of the computer 30. Consequently, the computer 30 can not only read the measuring instrument through the adapter 10 but also control the measuring instrument.

Then, the measuring instrument starts the test task. The process of the test task is similar to the conventional test process. The test result is transmitted to the computer 30 through the adapter 10 and shown through the test program. Consequently, the test result can be observed and judged by the operator or the engineer.

In accordance with another embodiment, if the adapter 10 has no parameter profile corresponding to the characteristic data of the measuring instrument, the adapter 10 generates the prompt message to notify the user (Step S5) and the adapter 10 further searches, downloads and updates the required setting data. As mentioned above, the adapter 10 is in communication with the computer 30 through the first transmission interface 13. Consequently, the computer 30 may be linked to the internet to search or read the associated data storage medium to acquire the required program code or driver. That is, the program code or driver can be directly transmitted and loaded to the database 120 of the adapter 10. Meanwhile, the program code or driver is updated.

In an embodiment, the process of updating the database 120 is performed by the adapter 10. For example, as shown in FIG. 1, the adapter 10 further comprises a network module 15. The network module 15 is in communication with a network server (not shown). The network server is specially used for updating the parameter profiles in order to load data to the database 120 or update the version of the database 120. In an embodiment, the network module 15 is a wireless network module. That is, the network module 15 is in communication with the network server in a wireless transmission manner. The network server is installed by the systematic developer. The network server can maintain and update the new and old versions of the setting information of the measuring instrument. In case that the network module is periodically or aperiodically connected with the network server, the database 120 can provide the optimized and newest testing service.

As mentioned above, the database 120 is recorded in the memory unit 12 of the adapter 10. Generally, the storage space of the memory unit 12 is limited. If the data amount of the memory unit 12 is too large, the database 120 cannot be updated. For solving this problem, the parameter profiles in the database 120 may be selectively retained or deleted. Consequently, the memory unit 12 has the sufficient storage space for subsequently updating the new data. If the deleted data needs to be used again, the adapter 10 may be connected to the network server according to the above method in order to load the new data. The way of deleting data is optionally done or set by the user. In an embodiment, after the parameter profile of the connected measuring instrument is transmitted to the computer through the adapter, the parameter profile is deleted from the database 120.

From the above descriptions, the present invention provides an adapter with an instrument control function, an instrument control system and an instrument control method. In comparison with the conventional technologies, the technologies of the present invention have many benefits. Firstly, the process of setting the measuring instruments of various model numbers or versions will be simplified. By automatically detecting the setting data of the connected measuring instrument through the adapter, the erroneous probability of the manual settings and the setting time will be reduced. Secondly, the parameter profile corresponding to the measuring instrument is directly transmitted to the computer according to the result of automatically comparing the characteristic data of the measuring instrument with the database. In comparison with the conventional technology of successively setting the measuring instrument, the technology of the present invention is user-friendly. Thirdly, the process of constructing the database of the present invention is possibly time-consuming and labor-intensive. However, the database can be maintained very easily because the old data are collaboratively managed and the new data are updated according to the practical requirements. The conventional maintaining method cannot achieve this purpose. Fourthly, the setting data associated with the old style of measuring instrument can be well maintained. Consequently, the selectivity of the measuring instrument for performing the task in the production line is enhanced.

The adapter, the instrument control system and the instrument control method of the present invention can solve the drawbacks of the conventional technologies while achieving the purposes of the present invention.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An adapter with an instrument control function, the adapter being connected between a computer and at least one measuring instrument, a test program being installed in the computer, each of the at least one measuring instrument having a characteristic data, the adapter comprising:
a first transmission interface in communication with the computer;
a second transmission interface in communication with the at least one measuring instrument;
a memory unit, wherein a database is recorded in the memory unit, and the database contains plural parameter profiles; and
a processing unit detecting the characteristic data of the at least one measuring instrument that is in communication with the second transmission interface, and judging a comparing result of comparing the characteristic data with the database,
wherein if a specified parameter profile of the plural parameter profiles corresponding to the characteristic data is present in the database according to the comparing result, the specified parameter profile is transmitted from the processing unit to the computer through the first transmission interface, wherein a setting of the test program is completed according to the specified parameter profile, and the test program executes a task of testing the corresponding measuring instrument.

2. The adapter according to claim 1, wherein the second transmission interface comprises plural transmission ports corresponding to at least one transmission specification of the at least one measuring instrument.

3. The adapter according to claim 1, wherein the characteristic data is related to a device name, a device model number, a device specification, a device manufacturer, a device number or a product identification number of the corresponding measuring instrument.

4. The adapter according to claim 1, wherein the plural parameter profiles in the database are obtained after program codes or drivers of plural known measuring instruments available in the market are collected and managed.

5. The adapter according to claim 1, wherein while the processing unit judges the comparing result of comparing the characteristic data with the database, the processing unit searches whether a record about the characteristic data is contained in the database.

6. The adapter according to claim 1, wherein the plural parameter profiles and the corresponding characteristic data are recorded in the database.

7. The adapter according to claim 1, wherein after a control command is generated by the test program and the control command is converted through the specified parameter profile, the converted control command is transmitted to the corresponding measuring instrument and the task of testing the corresponding measuring instrument is executed, wherein after the task of testing the corresponding measuring instrument is completed, a test result is generated and transmitted from the corresponding measuring instrument to the computer through the adapter, so that the test result is shown through the test program.

8. The adapter according to claim 1, wherein if no parameter profile corresponding to the characteristic data is present in the database according to the comparing result, the processing unit generates a prompt message.

9. The adapter according to claim 1, wherein the adapter further comprises a network module, and the network module is in communication with a network server so as to load data to the database or update a version of the database.

10. An instrument control system, comprising:
a computer, wherein a test program is installed in the computer;
at least one measuring instrument, wherein each of the at least one measuring instrument has a characteristic data; and
an adapter connected between the computer and the at least one measuring instrument, wherein the adapter comprises:
a first transmission interface in communication with the computer;
a second transmission interface in communication with the at least one measuring instrument;
a memory unit, wherein a database is recorded in the memory unit, and the database contains plural parameter profiles; and
a processing unit detecting the characteristic data of the at least one measuring instrument that is in communication with the second transmission interface, and judging a comparing result of comparing the characteristic data with the database,
wherein if a specified parameter profile of the plural parameter profiles corresponding to the characteristic data is present in the database according to the comparing result, the specified parameter profile is transmitted from the processing unit to the computer through the first transmission interface, wherein a setting of the test program is completed according to the specified parameter profile, and the test program executes a task of testing the corresponding measuring instrument.

11. An instrument control method for an instrument control system, the instrument control system comprising a computer, at least one measuring instrument and an adapter, a test program being installed in the computer, each of the at least one measuring instrument having a characteristic data, the instrument control method comprising steps of:
allowing the computer to be in communication with the first transmission interface of the adapter, and allowing the at least one measuring instrument to be in communication with a second transmission interface of the adapter;
allowing a processing unit of the adapter to detect the characteristic data of the at least one measuring instrument that is in communication with the second transmission interface, and judge a comparing result of comparing the characteristic data with a database of the adapter; and
if a specified parameter profile of the plural parameter profiles corresponding to the characteristic data is present in the database according to the comparing result, transmitting the specified parameter profile from the processing unit to the computer through the first transmission interface, wherein a setting of the test program is completed according to the specified parameter profile, and the test program executes a task of testing the corresponding measuring instrument.

12. The instrument control method according to claim 11, wherein the plural parameter profiles in the database are obtained after program codes or drivers of plural known measuring instruments available in the market are collected and managed.

13. The instrument control method according to claim 11, wherein while the processing unit judges the comparing result of comparing the characteristic data with the database, the processing unit searches whether a record about the characteristic data is contained in the database.

14. The instrument control method according to claim 11, wherein if no parameter profile corresponding to the characteristic data is present in the database according to the comparing result, the processing unit generates a prompt message.

15. The instrument control method according to claim 11, further comprising steps of:
allowing a network module the adapter to be in communication with a network server; and
allowing the network server to load data to the database or update a version of the database.
